(19) United States
(12) Patent Application Publication
(10) Pub. No.: US 2015/0261916 A1
(43) Pub. Date: Sep. 17, 2015

(54) System Development Dataset Preparation

(71) Applicant: Cerner Innovation, Inc., Kansas City, KS (US)

(72) Inventors: Craig S. Robinson, Downingtown, PA (US); Carl Mattias Lindenau, Gothenburg (SE)

(21) Appl. No.: 14/203,989

(22) Filed: Mar. 11, 2014

(51) Int. Cl. G06F 19/00; G06Q 50/24

(52) U.S. Cl. CPC G06F 19/322; G06Q 50/24

(57) ABSTRACT

The preparation of a data set for electronic health system development may involve processing a patient data set having confidential information through an electronic transaction in the electronic health system. Identifying the confidential data of the processed patient data set, and replacing the identified confidential data with replacement non-confidential data of a same data type as the identified confidential data in a representative transaction data set may also be involved.

### FIELD

The present embodiments relate to dataset preparation for use in system development. Specifically, the present embodiments relate to preparing datasets containing confidential information for use in system development in a non-confidential or non-secure environment.

### BACKGROUND

Healthcare facilities and organization use electronic systems to store and manage a considerable amount of medical data, from various sources and in various formats, for specific patients. This patient data may be processed in transactions with the electronic systems.

Some patient specific data is recognized as confidential data and should be protected from unnecessary access. For example, the Health Insurance Portability and Accountability Act of 1996 (“HIPAA”) establishes specific protected health information types and categories that should be protected from unauthorized access when associated with health information.

Healthcare facilities and organizations have put into place procedures to protect the patient specific data by limiting access to the patient specific data to healthcare professionals and others qualified to have access to the patient specific data. Generally, the systems used to process the patient specific data are built to operate within these types of procedures and work environments.

The development of healthcare systems is often performed by people not qualified to access patient specific data. Basic development of systems may be performed using generic data for system transactions. Specific data from specific system transactions may be needed to recreate issues that occur during system operation. The system specific transaction data, however, will contain patient specific data, and therefore cannot be used for developmental purposes. The lack of accurate transaction data for use in system development can cause significant inefficiencies during a development process as system developers are forced to guess at solutions and innovations to system issues without testing on the actual data being processed through the system.

### BRIEF SUMMARY

By way of introduction, the preferred embodiments described below include methods, computer readable media, and systems for preparing datasets containing confidential patient data for use in a system development environment. To facilitate the preparation of these datasets, data from specific system transactions are recorded. The confidential patient information is identified and replaced with non-confidential data that is similar in value and same in type to the confidential patient data.

In a first aspect, a method is presented for preparation of a data set for electronic health system development. The method may involve transferring a patient data set of at least one electronic transaction in an electronic health system operating in a secure environment, the patient data set comprising confidential data of at least one patient. The method may also involve saving the patient data set of the electronic transaction in the secure environment,

identifying the confidential data of the saved patient data set, replacing the identified confidential data with replacement non-confidential data in a representative transaction data set, and saving the representative transaction data set with other representative transaction data sets representing transactions occurring in the electronic health system over a period of time, wherein the representative transaction data set is stored such that any access of the representative transaction data set will not provide access to the confidential data.

In a second aspect, a system is presented for preparation of a data set for electronic health system development. The system may involve at least one memory operable to store data sets such as a patient data set comprising confidential data of at least one patient and a representative transaction data set. The system may also involve a processor configured to cause the system to receive the patient data set used in an electronic transaction in the electronic health system operating in a secure environment, identify the confidential data of the saved patient data set, replace the identified confidential data with replacement non-confidential data in a representative transaction data set, and output the representative transaction data set to the at least one memory.

In a third aspect, a non-transitory computer readable storage medium is provided having stored therein data representing instructions executable by a programmed processor for preparation of a data set for electronic health system development. The storage medium may involve instructions for processing a patient data set in the electronic health system operating in a secure environment, the patient data set comprising confidential data of at least one patient, identifying the confidential data of the processed patient data set, replacing the identified confidential data with replacement non-confidential data of a same data type as the identified confidential data in a representative data set, and saving the representative data set such that any access of the representative data set will not indicate the confidential data.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 shows a flow chart diagram of one embodiment of a method for transaction data set preparation;

FIG. 2 illustrates an embodiment involving a replacement of confidential information in a patient data set; and

FIG. 3 provides an illustrative embodiment of a computer system for preparation of a data set for healthcare system development.

### DETAILED DESCRIPTION OF THE DRAWINGS AND PRESENTLY PREFERRED EMBODIMENTS

The data from a transaction in an electronic healthcare system may be recorded. Any confidential data contained in the recorded transaction data may be removed and replaced with similar data that is not confidential. The resulting replacement transaction data set may be used by healthcare system developers to re-create transactions or further develop electronic healthcare systems. The replacement transaction data set may be stored without the confidential data, or any association with the confidential data. Thus the identification, replacement and current existence of the confidential data is hidden from a user that accesses the replacement transaction dataset. The replacement transaction data set will be considered the data set of the transaction for developmental purposes and other references and associations to the transaction. As such, the record of the transaction may be free of confidential data. Further, the resulting replacement transaction data set may be transmitted or otherwise transferred from the secure environment of a healthcare facility or organization to a non-secure environment such as a healthcare system developmental facility.

In an embodiment, a transactional processing tool may be provided that combines cryptographically obfuscating, replacing, and/or auditing confidential health information and/or date specific data during the capture of data processed through the transaction. The replacing of confidential health data may be performed by removing the original confidential health data and replacing the confidential health data with approved similar data, so as to scrub the transaction data free of the confidential health data. Therefore the transaction processing tool may operate to remove and hide confidential health data from a user of the tool by such transaction processing. The action of scrubbing the confidential health data may be recorded in a log and associated with the transaction that generated the transaction data. Such a log may be maintained in a secure environment and insulated from a user of the tool so as to further restrict access to the confidential health data by a tool user. Further, a mechanism may be provided to replay the transaction using scrubbed transaction data for later use in system solution support and/or testing. Also, the original confidential health data may be stored in association with the scrubbed transaction data such that the original confidential health data may be re-installed into the scrubbed transaction data to recreate the original transaction data. However, the original confidential health data will be separate from the scrubbed transaction data and maintained in a secure environment.

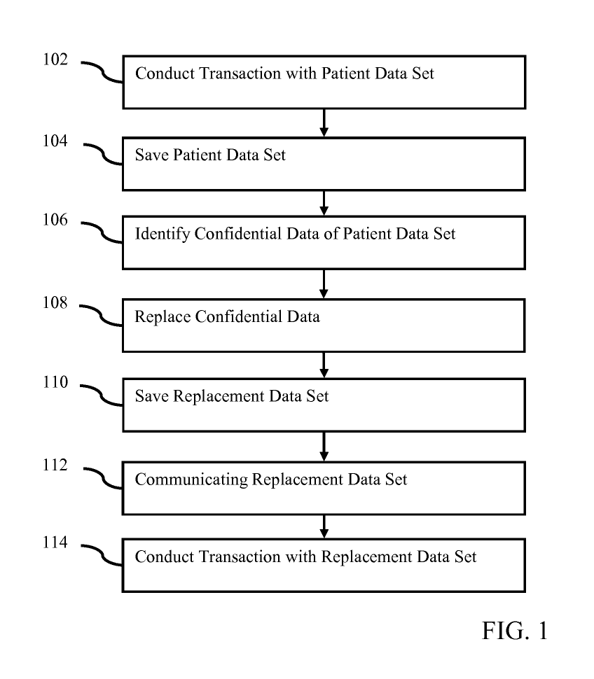

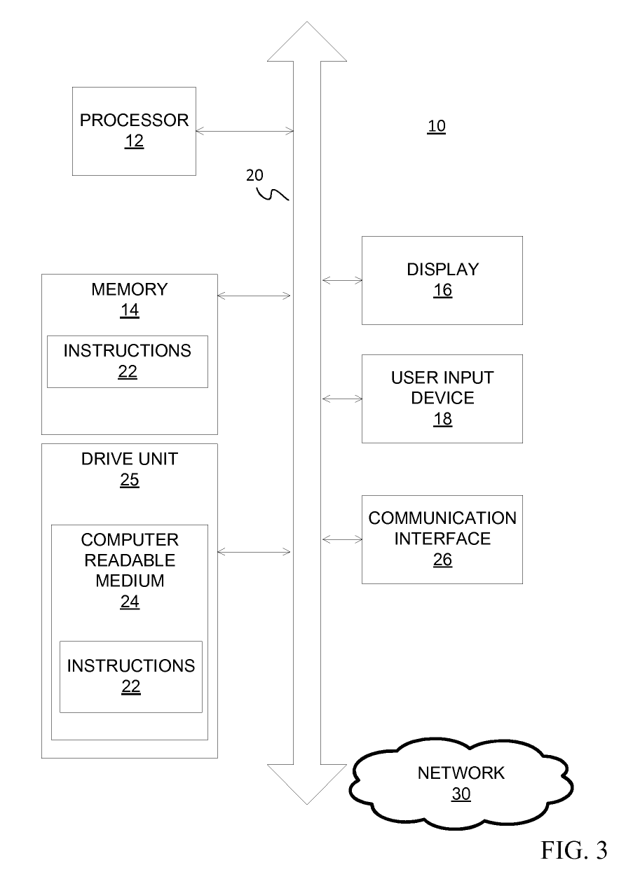

FIG. 1 shows a flow chart diagram of one embodiment of a method for transaction data set preparation. The method is implemented by a computerized physician order entry (CPOE) system, an automated workflow system, a review station, a workstation, a computer, a picture archiving and communication system (PACS) station, a server, combinations thereof, or other system in or associated with a medical facility. For example, the system, processor, and/or computer readable media shown in FIG. 3 implements the method, but other systems may be used.

Additional, different, or fewer acts may be performed. For example, an act for generating a log entry documenting the replacement of confidential data may be generated. In another example, acts 104, 10, and/or 112 may be omitted. The method is implemented in the order shown or a different order. For example, acts 104, 106, and/or 108 may be performed in parallel or repeated.

In act 102, patient data may be transferred as part of or involved in an electronic transaction in an electronic health system. The electronic medical record system may be operating in a secure environment. A patient data set may involve any collection of data relating to a singular or multiple patients of a healthcare facility or organization. The patient data set or other patient data may be transferred. Also, the patient data includes confidential data of at least one patient.

An electronic transaction may be considered any type of data exchange. For example, transfers, accumulation, or transmitting data may be an electronic transaction. The electronic transaction may be between two separate systems, or within a single system. Further, an electronic transaction may be between two memories, or involve rearranging data within a singular memory. In an embodiment, an electronic transaction may be considered the transfer of data that occurs between the opening and closing of a Transmission Control Protocol (“TCP”) port connection.

A transaction is any transfer, operation on, alteration of, addition, removal, or change in data and/or operation of the healthcare system. During the use of a healthcare system, user (e.g., physician or nurse) interaction with the electronic medical record is a transaction. For example, entry of an order for a test is a transaction. As another example, adding results, physician notes, diagnosis, query answers, or other information is a transaction. In yet another example, scheduling, occurrence, or confirmation of a visit, discharge or other event is a transaction.

An electronic health system may be any system involving the storage, entry, or manipulation of health data. For example, an electronic health system may be used by health facilities, insurance companies, or any other type of company working with confidential patient data.

In an embodiment, the electronic health system may be an Electronic Medical Record (“EMR”) system. Generally an EMR includes information collected over the course of a patient's treatment, or use of an institution or organization. The information may be collected using forms, form templates, form sections, or combinations thereof. The information may be input into the EMR by any method, including both automatic insertion and update through system data updating, or manual insertion or creation of data by health care professionals. For example, information entry may be nurses, physicians, or technicians of a medical facility. The information may include, for example, computed tomography (“CT”) images, X-ray images, laboratory test results, doctor progress notes, details about medical procedures, prescription drug information, radiological reports, other specialist reports, demographic information, family history, patient information, schedules, and billing(financial) information. Any of this information may be subject to an electronic transaction within the EMR, or with external systems.

An EMR may include a plurality of data sources, each of which typically reflects a different aspect of a patient's care. Alternatively, the EMR is integrated into one data source. Structured data sources, such as financial, laboratory, and pharmacy databases, generally maintain patient information in database tables. Information may also be stored in unstructured data sources, such as, for example, free text (e.g., physician's notes), images, and waveforms. Often, characteristics, such as key clinical findings, are stored within unstructured physician reports, annotations on images or other unstructured data source.

Confidential data may be any data where a need exists to keep access to the data limited to maintain the privacy of the data. For example, health information related to a medical facility patient or a patient's identity may be considered confidential. In another example, the health information may be confidential information involving a patient age, a patient geographic location, a healthcare facility in which treatment is provided, dates of patient treatment, a patient birthdate, patient contact information, and/or other patient identification information.

Some governments have designated specific categories of data that must be maintained as confidential in a health environment. For example, in the United States, HIPAA as enacted in 45 C.F.R. 164.514 outlines an operational safe harbor for medical facilities and organizations that involves the protection of a number of specific patient identifiers when associated with health data. Some of these patient identifiers involve names, dates, geographic subdivisions, telephone numbers, email addresses, and many other data that may be used to identify a patient.

A secure environment may be considered an environment that involves limiting access to confidential patient information to people qualified or legally allowed to access the confidential patient information. Such environments may exist in medical facilities and within healthcare organizations that have procedures, processes, and mechanisms in place to maintain the confidential nature of confidential patient information. Electronic transactions that take place in a secure environment may be considered secure electronic transactions. The security may be through physical access or through data access. For example, the EMR may be accessed or itself operated remotely from a healthcare facility, but only with a password.

In act 104, the patient data set of the electronic transaction may be saved. The data set may be saved on any device capable of storing the data set. For example, the memory 14 or computer readable medium 24 as described with respect to FIG. 3 may be used to store the patient data. The patient data set may be saved in any form. For example, the patient data set may be saved as formatted or structured data using forms or tables to organize the data of the data set. Also, the data may be saved in an unformatted or unstructured form. Further, the patient data set may be manipulated through the electronic transaction, and saved in a form designated as appropriate for the undertaking of the electronic transaction. Data just for the transaction or data of the patient for which the transaction occurs may be stored. The patient data set may be saved in a form intended to mimic or closely resemble the form of the data set used for the electronic transaction. For example, the patient data set may be reduced to an unstructured collection of text, and the patient data set may be stored as the same unstructured collection of text. In an embodiment, the patient data set is stored as a flat file. A flat file refers to data files that contain records with no structured relationships. Flat files may contain only basic formatting, have a small fixed number of fields, and may or may not have an associated file format.

In an embodiment, multiple transactions may be carried out simultaneously or in rapid succession in a batch processing environment. Transactions, and the data processed therein, may be saved, indexed, and/or associated. As such, a data set may involve data from multiple transactions and the specific data for each transaction may be identified. In an embodiment, the data of batched of transactions may be treated as a single data set.

In act 106, the confidential data of the patient data set may be identified. The confidential data may be identified using any technique capable of identifying confidential data from a data set. In an embodiment, the confidential data is stored in specific fields of a database designated as confidential fields. For example a “Patient Name Field” may contain data designated as confidential. Further, field names may be a source for the location of confidential information of other fields. For example, text data of a “Patient Name Field” may be used to locate similar text in other fields, such as unstructured text fields. The value of a field may be used to search for other occurrences in the data. Such a use may involve a “Patient Name Field” containing text such as “John Smith”. Consequently the text “John” may be identified, with or without combination with “Smith” in an unstructured text field, and the specific “John” text may be identified as confidential.

In an embodiment, any data identified as correlating to identity data specified under the HIPAA safe harbor operational directives is considered confidential patient data.

In act 108, the identified confidential data may be replaced with replacement non-confidential data to form a representative transaction data set. The replacement may be by any technique capable of replacing data in the saved data set with other data. A representative transaction data set may be considered a data set containing the original non-confidential data of an electronic transaction as well as the replacement non-confidential data intended to replace the identified confidential data such that the functional interaction of the representative transaction data set with the system as an electronic transaction is processed the same, or as similar as possible, to the interaction of the original patient data set of the original electronic transaction undertaken by the system. In this way, testing or development may be performed using the replacement data set. For example, if an electronic transaction results in an error, or unintended consequence, then the electronic transaction may be simulated or repeated during a troubleshooting or development process with the replacement data set and the system may be modified or manipulated to correct the error.

In an embodiment, the replacement non-confidential data involves data intended to mimic the confidential data that is being replaced. As such, the non-confidential data may be data of a same type as the confidential data that is being replaced. Data of a same type may be data of a same size, format, style, field structure, or other type characteristic of data that may affect how the data is handled by a system. For example, confidential text data may be replaced with text data. Further, the replacement text data may have a same or similar number of characters as the confidential text data. In another example, identified confidential data may be an X-Ray image of a patient saved as a Joint Photographic Experts Group (“JPEG”) image sized at 20 megabytes. Non-confidential data replacing the JPEG image may also then be a JPEG image sized at 20 megabytes. Further, the replacement JPEG image may be an image of any non-confidential subject or construction. For example, the replacement JPEG image may be a generic image designed to be scalable to match the size of a confidential image being replaced. A generic image for example may be simple design or picture that does not contain a subject of a confidential nature. The generic image is of a same imaging modality (e.g., x-ray), but may be of a different modality. Further, the colors of the replacement image may be chosen such that they are similar or the same as the colors of the confidential image being replaced. Similar colors may be considered colors deemed similar based just noticeable differences measures or other science and technology used to quantify and describe physically human or machine color perception such that the perception. Any average intensity, brightness, or other characteristic may or may not be matched. Alternatively, different color or other characteristics are provided.

In an embodiment, confidential data may be replaced with non-confidential data that maintains some context of the confidential data being replaced. For example, confidential patient name data may be replaced with data that indicates that the confidential data replaced was a patient name. This may be done using various techniques. In an example, a patient name field may contain the text data “Smith, John Q.”. The confidential information of the patient name field may have designated data to be used as replacement non-confidential data. Such data may include replacement text such as “{NameLast},{NameFirst} {NameOther}” that indicates the context of the confidential data replaced, patient name, without indicating the specific data being replaced. As can be seen from this example, indicators, such as brackets, may be used to indicate the existence of replacement non-confidential data. Further, the replacement data used to replace confidential data may be held consistent throughout a data set for multiple replacements of the specific confidential data being replaced. For example, a free text field may contain the text “John Public arrived in a comatose state.” In such text, John Public may be considered confidential information, and in reference to the previous example, the free text field data may be replaced with “{NameLast}̂{NameFirst} arrived in a comatose state.”

Further, context that indicates a subject or source origin for the confidential data may be maintained. For example, a patient data set may include multiple data records for a single patient as well as other patients. The context of the same patient may be maintained in the non-confidential replacement data, without indicating the confidential data being replaced. In an embodiment, designated text characters or groups of characters, may be used for designating context without relaying or communicating confidential data. For example, an ordinal may be used in combination with the replacement text data indicated above. Such an ordinal combination may indicate that “John Public” confidential text data be replaced with “{NameLast}̂{NameFirst}_{—}0001”, while other confidential patient name data for other patients may be replaced with the same replacement text but with different ordinals, such as “{NameLast}̂{NameFirst}_{—}0002”. The replacement context may be held consistent for a transaction, and may be reset or vary for a different transaction. For example, in a different patient data set for a different electronic transaction, “John Public” may be replaced with “{NameLast}̂{NameFirst}_{—}0002”. Alternatively, a list of replacement values is used to avoid adding the ordinal.

In an embodiment, confidential text data may be replaced with non-confidential text data having a same number of characters. For example, text “Smith, John” may be replaced with “XXXXX, XXXX”. Also, specific characters may be used to convey context of the confidential information, but be limited to the number of characters. For example text “Smith, John” may be replaced with “LXXXX, FXXX” such that the “L” designates a replaced last name and the “F” designates a replaced first name. Also, other characters such as ordinals may be used as indicated above to maintain consistency throughout a data set. For example text “Smith, John” may be replaced with “LXXX1, FXX1” throughout a data set to indicate that these are replacements for the same confidential data.

Some confidential data may be specifically indicated by regulations regarding the presentation of categories or classes of people. For example, information indicating that people are above a certain age may be specifically indicated as confidential information. Thus, presentations of data indicating some ages may not be found to be confidential data, whereas the data indicating other ages may be confidential data. In an embodiment, the confidential data involves an indicator of an age of a patient greater than a threshold age, and the replacement non-confidential data involves an indicator of an age less than the threshold age but in a same age range as the age of the patient. For example, a threshold age may be 89 years old and the replacement non-confidential data may involve an indicator that a patient is 88 years old whenever an age of a patient is indicated to be 89 years old or older. In this example, a patient who is 90 years old and a patient who is 88 years old may be considered to be in a same age range for medical or health treatment purposes, but the specific ages may require different treatment for confidentiality purposes.

In an embodiment, the confidential data involves date data having information indicating a specific day, month, and/or year for the date, and the replacement non-confidential data comprises information indicating a same year but information indicating a different day and a different month. For example, a date field may contain the confidential text data “Sep. 1, 2013” which may be replaced with non-confidential text data “Jan. 2, 2013.” In an embodiment, date data selected to replace confidential data may be randomly selected.

Where multiple dates are used in a patient data set, the sequence of dates after replacement may be maintained. In an embodiment, confidential date data may be indicated using a timestamp format. For example, the confidential date data may be indicated as “20130930111501-0400”. The confidential date data may be replaced with non-confidential data such as “{TIMESTAMP}_{—}0001-00000000”. In such a case, context relative to the data set for the confidential data may be communicated in the non-confidential data. The “{TIMESTAMP}” data indicates that the original confidential information was a timestamp. The “_{—}0001” may indicate that the time stamp is the first time stamp in the data set. Also, the zeroed value for the rest of the non-confidential data may indicate that the time stamp is the first time stamp, and as such occurs at a base time of “00000000”. Subsequent time stamps in the data set may similarly be replaced with non-confidential data such as “{messageTS}_{—}0002-00000005” which represents a second time stamp which indicated the second stamp occurred five seconds after the first time stamp.

In an embodiment, the confidential data of the patient data set may be identified and replaced with non-confidential data to create a representative transaction data set without, or prior to, saving the patient data set.

In an embodiment, the occurrence of replacing of confidential data may be recorded in a log. Further, the replacing occurrence may be associated with the electronic transaction that processed the patient data set, in the log or otherwise. These logs may be saved in a manner or format which meets auditing requirements for the protection of confidential data. Further, the logs may be stored in a secure environment to restrict access or visibility of the confidential data replacement to qualified users of the electronic health system.

Also, the original replaced confidential data may be stored in association with the representative transaction data set containing the non-confidential data for which the confidential data was replaced. In an embodiment, the original replaced confidential data may be stored and associated with the representative transaction data in such a manner that the replacement non-confidential data may be replaced by the original confidential data to recreate the original patient data set.

In act 110, the representative data set is saved. The replacement data set may be saved such that any access of the replacement data set will not provide access to the confidential data. In effect, the confidential data may be quarantined from access by a user accessing the replacement data set. For example, the representative data set may be saved separately from any association with, or record of, the confidential data that was replaced. In this way, any access of the replacement data set will not indicate the content of the confidential data replaced. The representative data set may be saved with other representative transaction data sets representing transactions occurring in the electronic health system over a period of time. Further, the other representative transaction data sets may represent all of the transactions that occur during the period of time. The period of time may be any length of time needed to adequately represent a period of time for multiple transactions of a health system. For example, the time period may involve 24 hours, thus providing a technician investigating an error during that 24 hours to have access to all representative transaction data for that period of time. Further, a time period may involve many transactions. For example, hundreds or even thousands of transactions may occur over a given period of time. Such significant transaction volume may be processed by a computer or processor in a relatively short time, such as within a minute or a few minutes, to create representative transaction data sets for each transaction using structure as described with respect to the system 10 of FIG. 3.

In an embodiment, the other representative transaction data sets representing transactions may involve replacement non-confidential data involving at least one text character designated as indicating a specific transaction being represented by individual representative transaction data sets of the other representative transaction data sets. For example, a name text string, such as “Josh Smith” may be replaced with non-confidential data such as “[First] [Last]0001-0005”. As such, the “0001” character set may indicate a recurrence of Josh Smith throughout the data set, and the text “0005” may indicate that the data set represents the fifth transaction that has occurred during a period of time.

In an embodiment, any confidential data, or record of the confidential data, is stored in a secure environment and the replacement data set is stored in an unsecure environment. In an embodiment, the representative data set may be saved as a flat file, for example as a plain text file. Images and other non-text or unstructured data of the representative data set may be stored separately from the flat file representative data set, but associated with the flat file representative data set. In an embodiment, the representative data set may also be stored in the secure environment, but separated from the confidential data.

In act 112, the representative transaction data set may be communicated to an unsecure environment or an environment with different access limitations. The representative transaction data set may be communicated using any technique capable of communicating, transmitting, or otherwise transferring the data.

An unsecure environment may be considered an environment that is not designed, designated, or otherwise intended for access to the confidential data. For example, an electronic healthcare system development facility may be operated by technicians and/or other professionals that are not qualified or otherwise allowed to have access to confidential data. The development facility may be secure, such as password protected and/or encrypted, but unsecure relative to the confidential information. In an embodiment, an electronic healthcare system development facility may be physically located separately from a secure healthcare facility. In another embodiment, the electronic healthcare system development facility may be a system operating within a secure healthcare facility and/or running the electronic healthcare system.

In act 114, the electronic transaction may be repeated using the representative transaction data set. The repeated transaction may be performed in the unsecure environment. Repeating the transaction may involve using a similar or copy of the same system to mimic the conditions of the electronic health system operating in a secure environment such that any errors may be repeated and studied.

Further, the repeated transaction may be performed as a part of the testing and/or development of electronic health systems, and may be performed in the unsecure environment using the representative transaction data set. An updated or modified electronic health system may be created based on this testing and/or development, and a modified electronic health system may be provided to a healthcare facility or organization to replace the existing electronic health system. In such an example, the further testing and/or development will occur in an unsecure environment, and the updated electronic health system may be communicated to the secure environment of the healthcare facility or organization.

Also, a user may be restricted from accessing the confidential information while the confidential data is being identified in act 106 and replaced in act 108. This restriction may be accomplished through any technique. In an embodiment, the restriction is a restriction of the presentation of the confidential data. For example, the confidential data will not be displayed to the user. Therefore, the user will not be exposed to the confidential data, and thus the confidential information is hidden from the user. Further, the restriction may take place in the secure environment. In an embodiment, the restriction is such that all access to the confidential information by the user is restricted or not allowed. This may be accomplished through the use of permissions that the access to the patient dataset is restricted to only authorized access components of a system that perform the acts of identifying and/or replacing. Therefore, a user may only have permission to access the replacement data set not containing the confidential information.

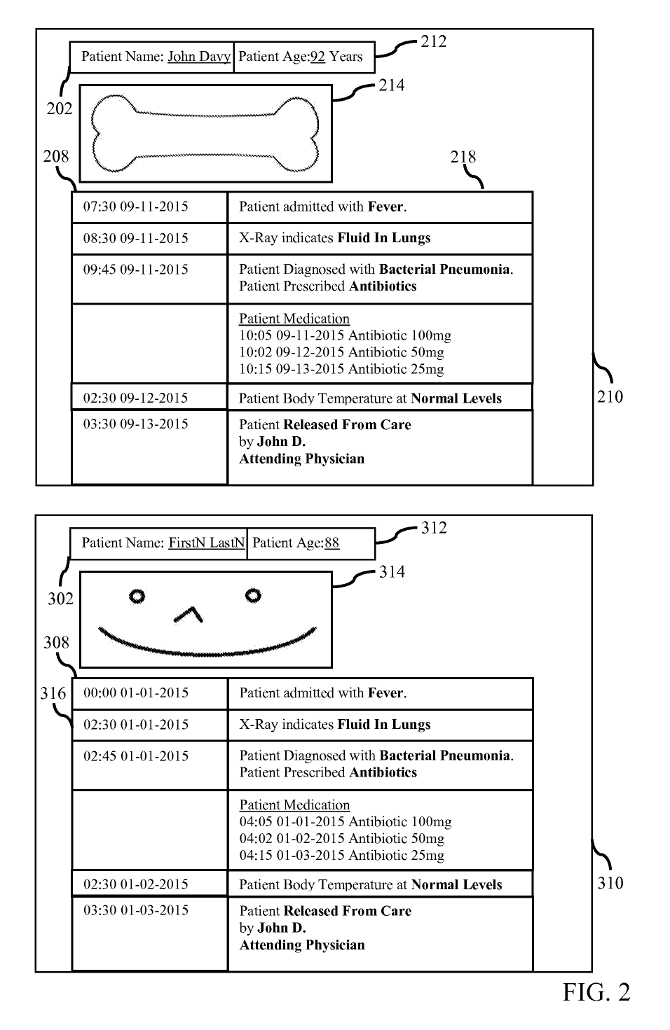

FIG. 2 illustrates an embodiment involving a replacement of confidential information in a patient data set 210. The patient data set 210 is a data set having confidential data 202, 212, 214, 208 stored in fields of a database and assembled into a patient data set 210 for use in an electronic transaction. The confidential information involves a patient name 202, a patient age 212, and an image 214 of the patient or related to the health of the patient. The patient data set 210 may also include other data 218 that when separated from patient identification data is not considered confidential information and does not require further confidential protection. The other data 218 may include time stamp data 208 that is considered confidential information when combined with the other data 218. In this embodiment, the patient data set 210 involves data relating to a single patient, however, in other embodiments a patient data set may involve data relating to multiple patients.

The confidential data 202, 212, 214, 208 may be removed and replaced with non-confidential data 302, 312, 314, 308, 316 to create a representative transaction data set 310. The patient name 202 may be replaced with non-confidential data 302 that involves a keyword that is not confidential, but carries context that the data was a name. Further, the confidential image 214 may be replaced with a replacement image 314 of a same type including file size, format and/or coloring. Also, the timestamps 208 of other information 218 may be replaced with non-confidential timestamps 308, 316 that do not discloses a specific time associated with the other data 218, but may carry a relative context from within the data set. For example, a first timestamp may be replaced with a zeroed time origin date stamp 308 that has all indicators of time other than the year set to an origin or beginning time. Subsequent time stamps of the patient data set 210 may be changed to relative incremental time stamps 316 that indicate a relative time from the time origin of the confidential time stamp 208.

In an embodiment, the representative transaction data set 310 may be used and considered the representative data of an electronic transaction. Further, access to the patient data set 210 may be restricted such that a user investigating the transaction may not have access to the patient data set 210. Further the confidential data 202, 212, 214, 208 may be restricted from the user after any replacement with the non-confidential data 302, 312, 314, 308, 316.

FIG. 3 provides an illustrative embodiment of a general computer system 10 for preparation of a data set for healthcare system development. The computer system 10 can include a set of instructions that can be executed to cause the computer system 10 to perform any one or more of the methods or computer based functions disclosed herein. The computer system 10 may operate as a standalone device or may be connected, e.g., using a network, to other computer systems or peripheral devices. Any of the embodiments discussed above may be implemented using the computer system 10, multiple computer systems 10, or a component in the computer system 10.

In a networked deployment, the computer system 10 may operate in the capacity of a server or as a client user computer in a client-server user network environment, or as a peer computer system in a peer-to-peer (or distributed) network environment. The computer system 10 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 10 can be implemented using electronic devices that provide voice, video or data communication. Further, while a single computer system 10 is illustrated, the term “system” shall also be taken to include any collection of systems or sub-systems that individually or jointly execute a set, or multiple sets, of instructions to perform one or more computer functions.

As illustrated in FIG. 3, the computer system 10 may include a processor 12, e.g., a central processing unit (CPU), a graphics processing unit (GPU), or both. The processor 12 may be a component in a variety of systems. For example, the processor 12 may be part of a standard personal computer or a workstation. The processor 12 may be one or more general processors, digital signal processors, application specific integrated circuits, field programmable gate arrays, servers, networks, digital circuits, analog circuits, combinations thereof, or other now known or later developed devices for analyzing and processing data. The processor 12 may implement a software program, such as code generated manually (i.e., programmed).

In an embodiment, the processor 12 may be configured to cause the system 10 to transfer a patient data set through an electronic transaction in the electronic health system operating in a secure environment, the patient data set comprising confidential data of at least one patient. The processor 12 may also be configured to cause the system 10 to identify the confidential data of the saved patient data set, and replace the identified confidential data with replacement non-confidential data in a representative transaction data set.

The computer system 10 may include a memory 14 that can communicate via a bus 20. The memory 14 may be a main memory, a static memory, or a dynamic memory. The memory 14 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 14 includes a cache or random access memory for the processor 12. In alternative embodiments, the memory 14 is separate from the processor 12, such as a cache memory of a processor, the system memory, or other memory. The memory 14 may be an external storage device or database for storing data. Examples include a hard drive, compact disc (“CD”), digital versatile disc (“DVD”), memory card, memory stick, floppy disc, universal serial bus (“USB”) memory device, or any other device operative to store data. The memory 14 is operable to store instructions executable by the processor 12. The functions, acts or tasks illustrated in the figures or described herein may be performed by the programmed processor 12 executing the instructions 22 stored in the memory 14. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 10 may further include a display unit 16, such as a liquid crystal display (LCD), an organic light emitting diode (OLED), a flat panel display, a solid state display, a cathode ray tube (CRT), a projector, a printer or other now known or later developed display device for outputting determined information. The display 16 may act as an interface for the user to see the functioning of the processor 12, or specifically as an interface with the software stored in the memory 14 or in the drive unit 25.

In an embodiment, the display 16 may be operable to present data sets to a user of the system 10.

Additionally, the computer system 10 may include an input device 18 configured to allow a user to interact with any of the components of system 10. The input device 18 may be a number pad, a keyboard, or a cursor control device, such as a mouse, or a joystick, touch screen display, remote control or any other device operative to interact with the system 10.

In a particular embodiment, as depicted in FIG. 3, the computer system 10 may also include a disk or optical drive unit 25. The disk drive unit 25 may include a computer-readable medium 410 in which one or more sets of instructions 22, e.g. software, can be embedded. Further, the instructions 22 may embody one or more of the methods or logic as described herein. In a particular embodiment, the instructions 22 may reside completely, or at least partially, within the memory 14 and/or within the processor 12 during execution by the computer system 10. The memory 14 and the processor 12 also may include computer-readable media as discussed above.

In an embodiment, the memory 12 or the computer readable medium 24 may be operable to store a patient data set and/or a representative transaction data set.

The present disclosure contemplates a computer-readable medium that includes instructions 22 or receives and executes instructions 22 responsive to a propagated signal, so that a device connected to a network 30 can communicate video, audio, images, text, or any other data over the network 30. Further, the instructions 22 may be transmitted or received over the network 30 via a communication interface 26. The communication interface 26 may be a part of the processor 12 or may be a separate component. The communication interface 26 may be created in software or may be a physical connection in hardware. The communication interface 26 is configured to connect with a network 30, external media, the display 16, or any other components in system 10, or combinations thereof. The connection with the network 30 may be a physical connection, such as a wired Ethernet connection or may be established wirelessly as discussed below. Likewise, the additional connections with other components of the system 10 may be physical connections or may be established wirelessly.

In an embodiment the instructions 22 may be operable when executed by the processor 12 to cause the system 10 to transfer a patient data set through an electronic transaction, identify confidential information in the patient data set, and replace the confidential information with non-confidential information to generate a non-confidential data set that is representative of the transaction.

In an embodiment, the processor 12 may cause a data set to be processed through a transaction with another system using the communication interface 26 via the network 30.

The network 30 may include wired networks, wireless networks, or combinations thereof. The wireless network may be a cellular telephone network, an 802.11, 802.16, 802.20, or WiMax network. Further, the network 30 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), or a tablet device, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

I (we) claim:

1. A method for preparation of a data set for electronic health system development, the method comprising:
transferring, by at least one processor, a patient data set of at least one electronic transaction in an electronic health system operating in a secure environment, the patient data set comprising confidential data of at least one patient;
saving the patient data set of the electronic transaction in the secure environment;
identifying the confidential data of the saved patient data set;
replacing the identified confidential data with replacement non-confidential data in a representative transaction data set; and
saving the representative transaction data set with other representative transaction data sets representing transactions occurring in the electronic health system over a period of time, wherein the representative transaction data set is stored such that any access of the representative transaction data set will not provide access to the confidential data.

2. The method of claim 1, wherein the confidential information comprises a patient age, a patient geographic location, a healthcare facility in which treatment is provided, dates of patient treatment, a patient birthdate, patient contact information, or patient identification information.

3. The method of claim 1, wherein the replacement non-confidential data is different data of a same data type as the confidential data being replaced by the non-confidential data.

4. The method of claim 3, wherein the non-confidential data comprises at least one text character designated as indicating a context of the confidential data being replaced.

5. The method of claim 3, wherein the confidential data comprises date data involving information indicating a specific day, month, and year for the date, and the replacement non-confidential data comprises information indicating a same year but information indicating a different day and a different month.

6. The method of claim 3, wherein the confidential data comprises an indicator of an age of a patient greater than a threshold age, and the replacement non-confidential data comprises an indicator of an age less than the threshold age but in a same age range as the age of the patient.

7. The method of claim 6, wherein the threshold age is 89 years old and the replacement non-confidential data comprises an indicator that the patient is 88 years old.

8. The method of claim 1, wherein replacing the confidential data with replacement non-confidential data in a representative transaction data set is recorded as an activity in a log.

9. The method of claim 1, further comprising:
communicating the representative transaction data set to an unsecure environment.

10. The method of claim 1, wherein the confidential information is not presented to a user during the identifying or replacing.

11. The method of claim 1, further comprising:
repeating the secure electronic transaction using the representative transaction data set.

12. The method of claim 1, wherein the at least one electronic transaction comprises a plurality of transactions carried out in a batch processing environment.

13. The method of claim 1, wherein the other representative transaction data sets representing transactions comprise replacement non-confidential data involving at least one text character designated as indicating a specific transaction being represented by individual representative transaction data sets of the other representative transaction data sets.

14. A system for preparation of a data set for electronic health system development, the system comprising:
at least one memory operable to store a data sets such as a patient data set comprising confidential data of at least one patient and a representative transaction data set; and
a processor configured to cause the system to:
receive the patient data set used in an electronic transaction in the electronic health system operating in a secure environment;
identify the confidential data of the saved patient data set;
replace the identified confidential data with replacement non-confidential data in a representative transaction data set; and
output the representative transaction data set to the at least one memory.

15. The system of claim 14, wherein the confidential information comprises a patient age, a patient geographic location, a healthcare facility in which treatment is provided, dates of patient treatment, a patient birthdate, patient contact information, or patient identification information.

16. The system of claim 14, wherein the replacement non-confidential data is different data of a same data type as the confidential data being replaced by the non-confidential data.

17. The system of claim 16, wherein the non-confidential data comprises at least one text character designated as indicating a context of the confidential data being replaced.

18. The system of claim 16, wherein the confidential data comprises date data involving information indicating a specific day, month, and year for the date, and the replacement non-confidential data comprises information indicating a same year but information indicating a different day and a different month.

19. The system of claim 16, wherein the confidential data comprises an indicator of an age of a patient greater than a threshold age, and the replacement non-confidential data comprises an indicator of an age less than the threshold age but in a same age range as the age of the patient.

20. The system of claim 17, wherein the processor is further configured to cause the system to repeat the secure electronic transaction using the representative transaction data set.

21. A non-transitory computer readable storage medium having stored therein data representing instructions executable by a programmed processor for preparation of a data set for electronic health system development, the storage medium comprising instructions for:
processing a patient data set in the electronic health system operating in a secure environment, the patient data set comprising confidential data of at least one patient;
identifying the confidential data of the processed patient data set;
replacing the identified confidential data with replacement non-confidential data of a same data type as the identified confidential data in a representative data set; and
saving the representative data set such that any access of the representative data set will not indicate the confidential data.

22. The medium of claim 21, wherein the confidential information comprises a patient age, a patient geographic location, a healthcare facility in which treatment is provided, dates of patient treatment, a patient birthdate, patient contact information, or patient identification information.

23. The medium of claim 21, wherein the non-confidential data comprises at least one text character designated as indicating a context of the confidential data being replaced.

24. The medium of claim 21, wherein the confidential data comprises date data involving information indicating a specific day, month, and year for the date, and the replacement non-confidential data comprises information indicating a same year but information indicating a different day and a different month.

25. The medium of claim 21, wherein the confidential data comprises an indicator of an age of a patient greater than a threshold age, and the replacement non-confidential data comprises an indicator of an age less than the threshold age but in a same age range as the age of the patient.

26. The medium of claim 21, wherein a user is restricted from accessing the confidential information during the identifying and replacing.
